(19) United States
(12) Patent Application Publication
(10) Pub. No.: US 2015/0097978 A1
(43) Pub. Date: Apr. 9, 2015

(54) SYSTEM AND METHOD FOR HIGH FIDELITY, HIGH DYNAMIC RANGE SCENE RECONSTRUCTION WITH FRAME STACKING

(71) Applicant: QUALCOMM Incorporated, San Diego, CA (US)

(72) Inventor: Ji Soo Lee, San Diego, CA (US)

(73) Assignee: QUALCOMM Incorporated, San Diego, CA (US)

(21) Appl. No.: 14/047,843

(22) Filed: Oct. 7, 2013

(51) Int. Cl. H04N 5/235; H04N 5/357; H04N 5/232

(52) U.S. Cl. CPC H04N 5/2355; H04N 5/23267; H04N 5/357
USPC 348/208.6

(57) ABSTRACT

Methods, devices, and computer program products for high fidelity, high dynamic range scene reconstruction with frame stacking are described herein. One system and method includes systems and software for capturing a plurality of images with the same exposure parameters, including a first exposure length. The plurality of images is then combined into a first image using a motion compensation algorithm. A second image is also captured with a second exposure length, where the second exposure length is longer than the first exposure length. Finally, the first and the second images are combined to provide a high dynamic range image.

### FIELD

The present application relates generally to digital imaging, and more specifically to systems, methods, and devices for high fidelity, high dynamic range scene reconstruction with frame stacking.

### BACKGROUND

In digital imaging, the dynamic range of a complementary metal-oxide-semiconductor (CMOS) sensor may, at times, be insufficient to accurately represent outdoor scenes in a single image. This may be especially true in the more compact sensors which may be used in mobile devices, such as in the camera on a mobile telephone. For example, a typical sensor used in a mobile device camera may have a dynamic range of approximately 60-70 dB. However, a typical natural outdoor scene can easily cover a contrast range of 100 dB between brighter areas and areas with shadows. Because this dynamic range is greater than the dynamic range of a typical sensor used in a mobile device, detail may be lost in images captured by mobile devices.

One method which has been used to compensate for this lack of dynamic range is to combine two or more frames into a single image with a higher dynamic range. For example, two or more frames with different exposure lengths may be combined into a single image. However, one problem with previous techniques for combining multiple frames into a single image has been a signal-to-noise ratio discontinuity between frames of different exposure lengths. One method which may be used to demonstrate this problem is to capture a grey ramp test chart using multiple exposures. In the portion of the grey ramp test chart corresponding to a transition point between two successive frame exposures, higher levels of luma and chroma noise may be observed. Such noise discontinuity may negatively affect image quality.

### SUMMARY

The systems, methods, devices, and computer program products discussed herein each have several aspects, no single one of which is solely responsible for its desirable attributes. Without limiting the scope of this invention as expressed by the claims which follow, some features are discussed briefly below. After considering this discussion, and particularly after reading the section entitled “Detailed Description,” it will be understood how advantageous features of this invention include robust estimation of color-dependent measurements.

In some aspects, a method of capturing a high dynamic range image is provided. The method includes capturing a plurality of images with the same exposure parameters, including a first exposure length; combining the plurality of images into a first image using a motion compensation to prevent image blur; capturing a second image with a second exposure length, the second exposure length longer than the first exposure length; and combining the first image and the second image to form the high dynamic range image. Capturing a second image with a second exposure length may include capturing a plurality of second images with a second exposure length. Capturing a plurality of images with the same exposure parameters may include capturing three or more images with a first exposure length. Capturing a second image with a second exposure length may include capturing a plurality of second preliminary images with a second exposure length, further comprising combining the plurality of second preliminary images into a second image using a motion compensation algorithm. The plurality of images may include images captured for consecutive frames of a video.

In some aspects, an electronic device is provided. The electronic device includes a CMOS visible image sensor; and a processor configured to capture a plurality of images with the same exposure parameters, including a first exposure length; combine the plurality of images into a first image using a motion compensation algorithm; capture a second image with a second exposure length, the second exposure length longer than the first exposure length; and combine the first image and the second image.

In some aspects, an electronic device is provided. The electronic device includes means for capturing a plurality of images with the same exposure parameters, including a first exposure length; means for combining the plurality of images into a first image using a motion compensation algorithm; means for capturing a second image with a second exposure length, the second exposure length longer than the first exposure length; and means for combining the first image and the second image.

In some aspects, a non-transitory, computer readable medium comprising instructions that when executed cause a processor in a device to perform a method of capturing an image is described. The method includes capturing a plurality of images with the same exposure parameters, including a first exposure length; combining the plurality of images into a first image using a motion compensation algorithm; capturing a second image with a second exposure length, the second exposure length longer than the first exposure length; and combining the first image and the second image.

### BRIEF DESCRIPTION OF THE DRAWINGS

FIG. 1 is a line graph showing an illustration of signal-to-noise ratio discontinuities which may occur when multiple frames are combined into a single image.

FIG. 2 is a block diagram of an exemplary proposed method of exposure bracketing.

FIG. 3 is a block diagram showing a method of frame stacking multiple short exposure frames to generate a higher fidelity frame.

FIG. 4 is a line graph showing an improvement to signal-to-noise ratio discontinuities which may occur based on embodiments of the invention.

FIG. 5 is an illustration of a timing chart which may be used to capture video on a display of pixels.

FIG. 6 illustrates a timing diagram which may be used in a HDR video capture process.

FIG. 7 is a block diagram that illustrates a method of an image signal processor controlling an image sensor to enable HDR video.

FIG. 8 is a block diagram that illustrates a method of exposure stepping enabling between an image signal processor and an Image Sensor.

FIG. 9 is flow chart showing an exemplary method of capturing an image.

FIG. 10 depicts a high-level block diagram of a device having a set of components including a processor operatively coupled to an image sensor.

### DETAILED DESCRIPTION

Embodiments relate to systems, methods, and devices for high fidelity, high dynamic range scene reconstruction with frame stacking. In such a method, frames of two or more exposure lengths may be combined into a single image with higher dynamic range. One method may include taking a number of frames corresponding to the shorter exposure frame length used, and then using motion-compensated frame stacking to improve the fidelity of the frame, and reduce the noise in the frame, prior to combining the shorter exposure length frame with one or more longer exposure length frame frames.

In some aspects, such a technique of combining multiple shorter exposure length frames into a single frame may increase motion blur in the shorter exposure length frames. However, in static scenes or in bright scenes (where even the longest exposure length is relatively short), the additional capture of one or more shorter exposure length frames may not significantly increase the motion blur in such a combined image. Moreover, motion compensated frame stacking techniques may be used, which may further reduce motion blur issues in images made up of a combination of shorter exposure length frames. By combining a number of shorter exposure length frames using such techniques, motion blur may be minimized, while also significantly reducing the noise in such a combined image.

In a high dynamic range video mode, a shorter exposure frame may be taken from a subsequent exposure bracket set, which may not necessitate taking any additional frames other than what an image sensor may already be outputting. Accordingly, a multimedia processor may be able to opportunistically exploit a shorter exposure frame of a next set based on a determination of the additional motion blur that the resulting frame stacking may incur.

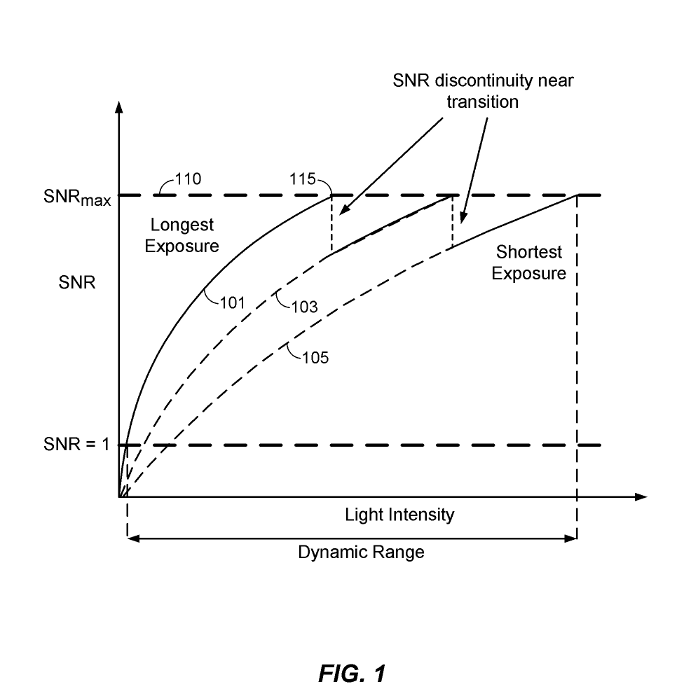

FIG. 1 is a graph showing signal-to-noise (SNR) ratio discontinuities which may occur when multiple image frames are combined into a single image. For example, an image may be made up of a first frame having a first SNR curve 101, a second frame having a second SNR curve 103, and a third frame having a third SNR curve 105. For a given image sensor, there may be a maximum attainable signal-to-noise ratio, given as SNRₘₐₓ 110. For example, the best SNR may be obtained as the image sensor reaches its well capacity. For any given light intensity, the single image may be based primarily on image information received from the frame which has the highest SNR, but has not reached full-well capacity.

Accordingly, when three frames of different exposure lengths are combined, there may be two transition points. For example, at a transition point 115, pixels with a light intensity less than this value may be based primarily on SNR information 101 from the first frame, while pixels with a light intensity above this value may be based on SNR information 103 from the second frame. In some aspects, transition point 115 may represent a level of light at which a frame with a longer exposure length, such as the first frame, reaches a full-well capacity. As illustrated in FIG. 1, at this transition point 115, there may be a large SNR discontinuity, such that pixels with a light intensity of less than transition point 115 exhibit a high SNR, while pixels with a light intensity of more than transition point 115 exhibit a much lower SNR.

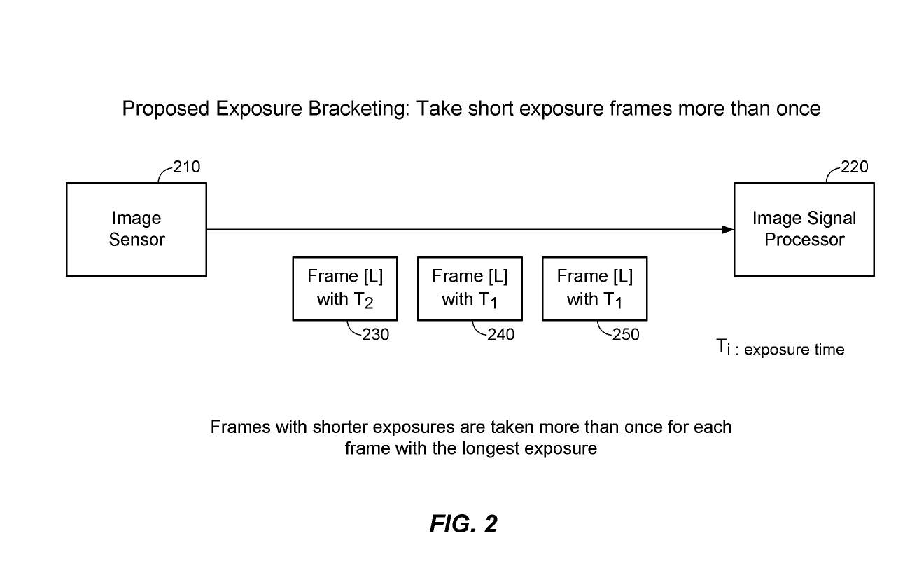

FIG. 2 is an illustration of a method of exposure bracketing according to one embodiment. In this method, frames with a shorter exposure may be taken more than once. For example, an image sensor 210 captures three images and sends those images to an image signal processor 220. The first frame 230 having a longer exposure is captured using an exposure time T₂, and a second frame 240 and third frame 250 are captured at a relatively shorter exposure time T₁. In some aspects, more than two frames with an exposure length T₁ may be used to create the combined image, where T₁ is a shorter exposure length than T₂. As discussed above, these multiple frames with exposure length T₁ may be combined with each other prior to being combined with the first frame 230 with the exposure length T₂. These multiple shorter-exposure frames may be combined using a motion compensation frame stacking technique in order to reduce motion blur.

For example, the first frame 230 may be captured using a normal exposure length. The length of such an exposure may be determined at least on part based on the level of ambient light. For example, in a darker environment, the first frame 230 may have a longer exposure length. The exposure length of the first frame 230 may also be determined at least in part based on the type of device that is taking the image. For example, a mobile phone with an integrated camera may use exposure lengths of 10 ms or less, as such a device may typically be handheld. A handheld device may have shorter exposure lengths than a device on a tripod or other more stable set up, as longer exposure lengths may lead to blurrier images on a handheld camera. The second frame 240 and third frame 250 may be of an equal, shorter exposure length. For example, the second frame 240 may have an exposure length that is equal to a half, a third, a quarter, or a tenth of the exposure length of the first frame 230. The exposure length of the second frame 240 may be determined, at least in part, based upon the brightness of some of the brightest objects in an image. For example, in an image that includes a direct light source such as a light, it may be preferable for the second frame 240 to have a shorter exposure length.

In some aspects, more than two frames with a shorter exposure length may be used to create a single high-fidelity, high dynamic range frame. For example, three frames with a shorter exposure length may be used to create a single high-fidelity, high dynamic range frame. In some aspects, the use of three frames may be beneficial, and may not require additional capture time, when T2 is greater than or equal to three times T1.

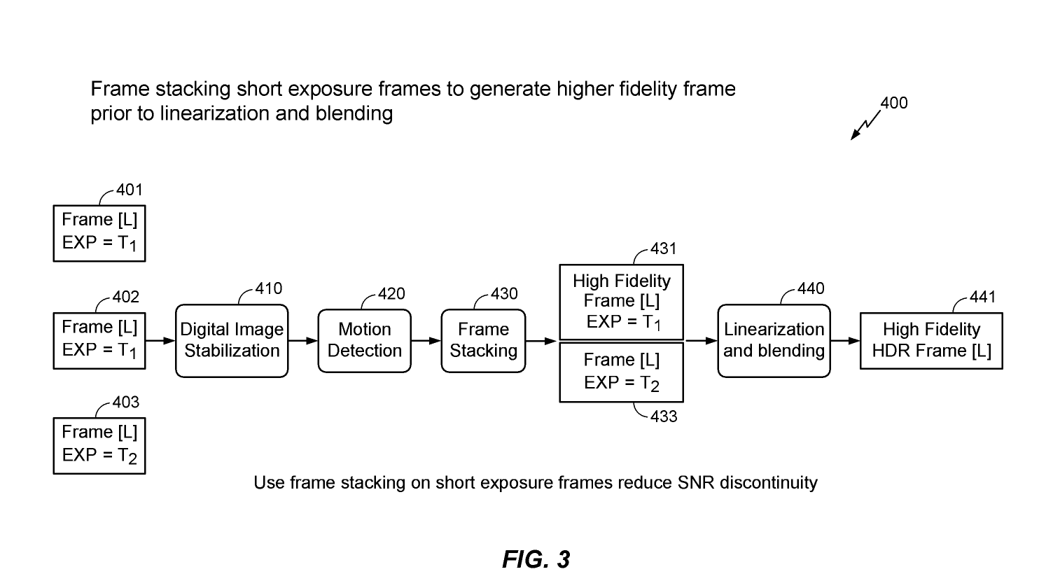

FIG. 3 is an illustration of one embodiment of a method 400 of frame stacking multiple short exposure frames to generate a higher fidelity frame. For example, this method may be used with the method of FIG. 2, in which two frames 240, 250 with a shorter exposure length, T1, were taken and one frame with a longer exposure length 230, T2 was taken. Initially, each of the frames 401, 402, 403 are first fed into a digital image stabilization block 410. The digital image stabilization block is configured to process the frames in order to reduce the blurriness of any images captured by the image sensor. For example, digital image stabilization may determine whether the camera has moved slightly between different frames, and may move each pixel in a frame to match those of another frame.

After this, the process 400 moves to a block 420 wherein techniques for motion detection 420 may be used. For example, motion detection and compensation may include choosing a reference frame. For example, either of the two frames 240, 250 may be used as a reference frame. In the case where a number of shorter exposure frames are used, the reference frame may be the first frame, the last frame, a middle frame, or another frame. In some aspects, the reference frame may be the long exposure frame, such as the first frame 230. After a reference frame is chosen, the other frames may be compared to the reference frame. An algorithm may be used to determine movement between a given frame and the reference frame. For example, if a number of images are taken of a pitcher pitching a baseball, the pitcher's arm may be in a different location in different frames. The algorithm may compare the location of the pitcher's arm in the reference frame to that in a given frame, and may digitally move the pitcher's arm in the given frame to align it with where the pitcher's arm is in the reference frame. The algorithm may further perform de-noising, in order to fill in the location where, for example, the pitcher's arm was moved from, in order to draw a background for that location of the given frame. This process may be repeated for each frame, by comparing the frame to the reference frame, identifying moving objects in the frame, moving those objects to the location they are in the reference frame, and de-noising to fill in the background of the area of the moved object in the frame.

After the motion detection and compensation is performed at block 420, the process 400 moves to block 430 where frame stacking techniques may be used. For example, after the different frames have been stabilized and motion has been compensated, the frames may be stacked using a number of techniques. For example, the pixels of the different frames may be averaged with each other. In some aspects, a weighted average may be used, in which one frame is given a higher weight than other frames. For example, the first frame or the last frame may be given more weight that other frames. The use of image stabilization and motion compensation may reduce blurriness in combined images that results from frame stacking. Thus, a combined image may be formed from each of the frames with exposure length T1 with reduced motion blur. These techniques may be used to form a high fidelity frame 431 with an exposure time T1, which has reduced motion blur compared to other combined frames, and which has a higher SNR compared to a single shorter exposure frame.

After using a motion compensation frame stacking technique at block 430 on the frames with a shorter exposure length T₁, the higher fidelity frame with exposure length T₁ 431 may be combined with the frame with exposure length T₂ 433 in order to form a single high fidelity, high dynamic range frame 441 using linearization and blending at a block 440. For example, linearization may include applying a gain to the shorter-exposure image, in order to adjust the relative brightness of that image compared to the longer-exposure image. Without this gain, the shorter-exposure image may appear much darker than the longer-exposure image. Blending may include applying motion compensation, as above to the two images. In some aspects, the motion compensation of the shorter exposure frames may be based upon using the longer exposure frame as a reference frame, for example. The combined shorter exposure frame may have its gain adjusted, and then may be merged with the longer exposure frame. For example, these two frames may be averaged on a pixel-by-pixel basis. In some aspects, a weighted average may be used, where one of the images may be accorded a higher weight than the other.

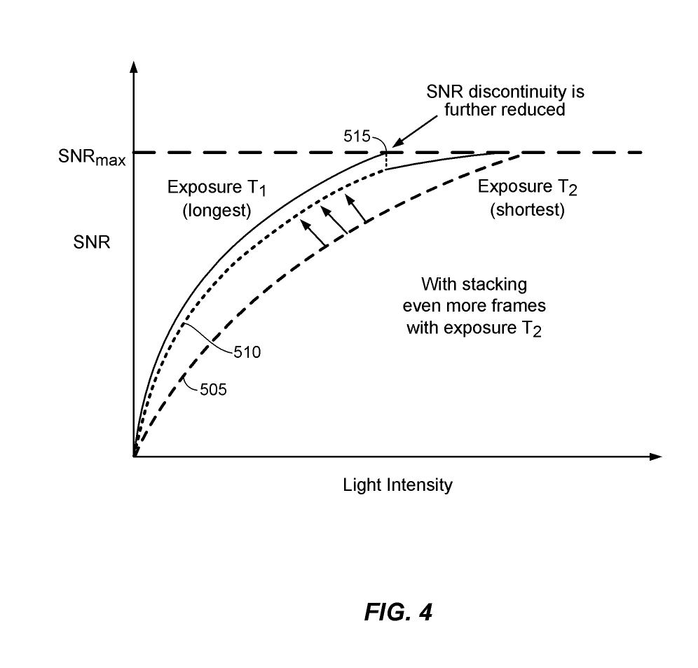

FIG. 4 is a line graph showing that an exemplary improvement to signal-to-noise ratio discontinuities which occurs based on embodiments of the methods and systems described herein. For example, if a single shorter exposure frame with an exposure T2 is used, its SNR curve 505 may be represented as illustrated. However, by combining a number of shorter exposure frames with an exposure T2, this may significantly improve the SNR in the combined frame. For example, this combined frame may be represented by the SNR curve 510. The combined SNR curve 510 may have a higher SNR for all levels of light than the single frame SNR curve 505. Accordingly, the difference between the SNR of exposure T1 and that of exposure T2 may be reduced at the transition point 515. Accordingly, an image using the proposed techniques may exhibit significantly smaller SNR disparities between different light intensity levels in an image.

Another embodiment is a system and method of frame stacking multiple short exposure frames from a current set with those of a next set. For example, this method may be used while taking a video, such that exposures taken for a first frame of the video may be combined with exposures taken for a preceding or subsequent frame. For example, two exposure frames may be taken for single frame [L] of a video. For each frame of the video itself, one exposure frame may be taken with an exposure length T₂ and one exposure frame may be taken with an exposure length T₁. Similarly, for frame [L+1], two exposure frames may be taken, with an exposure length of T₁ and T₂ respectively. In this embodiment, T₁ may be a shorter exposure length than T₂. Accordingly, in some aspects, two or more exposures frames with the shorter exposure length, T₁, from adjacent frames of a video, such as frame [L] and frame [L+1] may be combined with each other.

In combining the multiple frames with an exposure length T₁, motion compensation frame stacking techniques may be used, in order to reduce the SNR discontinuities in a combined image, similar to that described above. This method may be advantageous in that it does not require the capture of additional frames over those which might otherwise be captured in such a video technique. For example, this technique uses only the frames of a video that would otherwise be taken in a video which uses two exposure lengths per frame, but may result in significantly smaller SNR discontinuities than typical previous techniques.

In some aspects, frame stacking may be used with both the longer and the shorter exposure frames of an image. For example, multiple shorter exposure frames may be combined with each other, as described above. Multiple longer exposure frames may also be combined together in a similar manner. For example, in a video which uses two different exposure lengths in each frame of video, both the longer and the shorter exposure frames may be combined with the frames of similar lengths from adjacent video frames. For example, two shorter exposure length frames, with an exposure length T1 and taken in video frames [L] and [L+1] may be combined into a high fidelity frame, as discussed above. Similarly, two longer exposure length frames, with an exposure length T2 and taken in video frames [L] and [L+1] may be combined into a high fidelity frame. These two high fidelity frames may then be combined into a single high fidelity high dynamic range frame.

Combining multiple longer exposure frames may be done in a manner similar to combining multiple shorter exposure length frames. For example, it may be desirable to use a motion compensation frame stacking technique to combine the longer exposure frames. Such a combination of the longer exposure length frames may be done prior to combining the shorter and longer exposure length frames together. When this method is done on a video, such a method may not require the capture of additional longer exposure length frames, as these frames may be captured in a video regardless of the use of the method. In some aspects, more than two longer exposure length frames may be used.

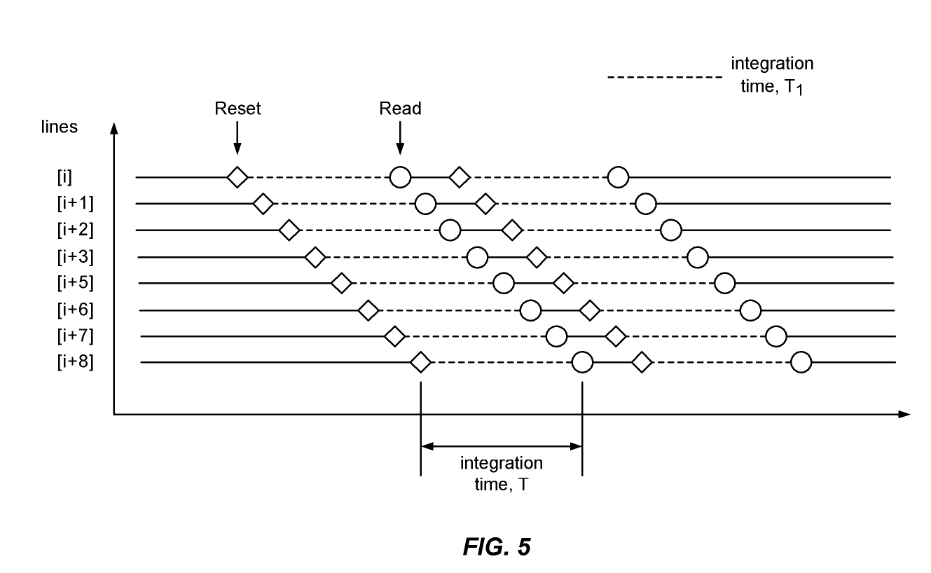

FIG. 5 is a timing diagram which may be used to capture video on a display of pixels. For example, each row of pixels may be integrated for an integration time T. Each row of pixels may be numbered, such as [i], [i+1], and so on. Integration times for each row of pixels may be the same, and these times may be coordinated such that an integration for a row of pixels, such as row [i+1] begins shortly after an integration for the previous row of pixels, [i].

During a video capture process, such as that in FIG. 5, an image signal processor or external multimedia processor may request to change the exposure length. However, in some conventional processes, such a request may not yield a frame-to-frame exposure change. Such a frame-to-frame exposure change may be desired in high dynamic range video. However, in typical video modes, requested exposure changes may not take effect on the next frame, but rather, may take affect two frames after the current frame. In modes other than HDR video, such a delay may not be a significant issue, since exposure changes may occur gradually. However, during HDR video readout, it may be beneficial for each successive frame to be made of precisely-controlled exposure times. Accordingly, a stringent requirement on how frame-to-frame exposure changes are controlled may be desired. In previous devices, such frame-to-frame exposure changes may be difficult to control from an ISP, since the exposure change requests are not guaranteed to occur on a following frame, but most often occur on an “N+2” frame (a frame two frames after the current frame). Accordingly, it may be desirable for an ISP to be able to send a request for a certain mode, with predefined exposure lengths. For example, an ISP may be able to request a mode in which a longer-exposure frame is taken followed by one or more shorter-exposure frames. The ISP may also be able to request that this cycle of exposure lengths be repeated, such as in an HDR video mode in which one longer-exposure frame and two shorter-exposure frames are used to create each frame of the video. In some aspects, the ISP may request a mode in which three or more different exposure length may be used, such as a short, medium and a long exposure frame.

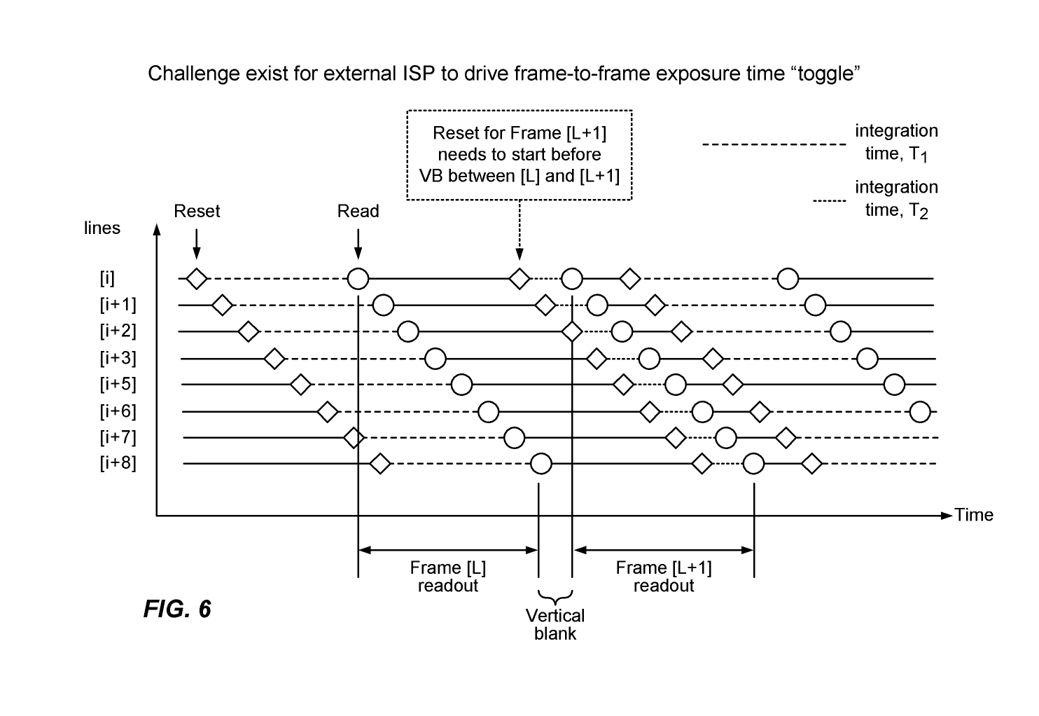

FIG. 6 illustrates a timing diagram which may be used in a HDR video capture process. For example, on each line, a frame [L] with an integration time Ti may be read out. Following this readout on all lines, a next frame [L+1] with an integration time T2 may be read out. In some aspects, a frame of HDR video may be made up of at least one frame of integration time T1, and at least one frame of integration time T2. In some aspects, it may be desired for an ISP to be able to control exposure length of a next exposure, such as to control the exposure length of frame [L+1] during frame [L], in order for the ISP to control an HDR video capture process which requires exposure length changes on a frame-to-frame basis. Such control may not be possible in previous implementations, as requests must be made on a frame-by-frame basis, and the timing of frames may not allow enough time for an ISP to request a longer exposure frame and then a shorter exposure frame or vice versa

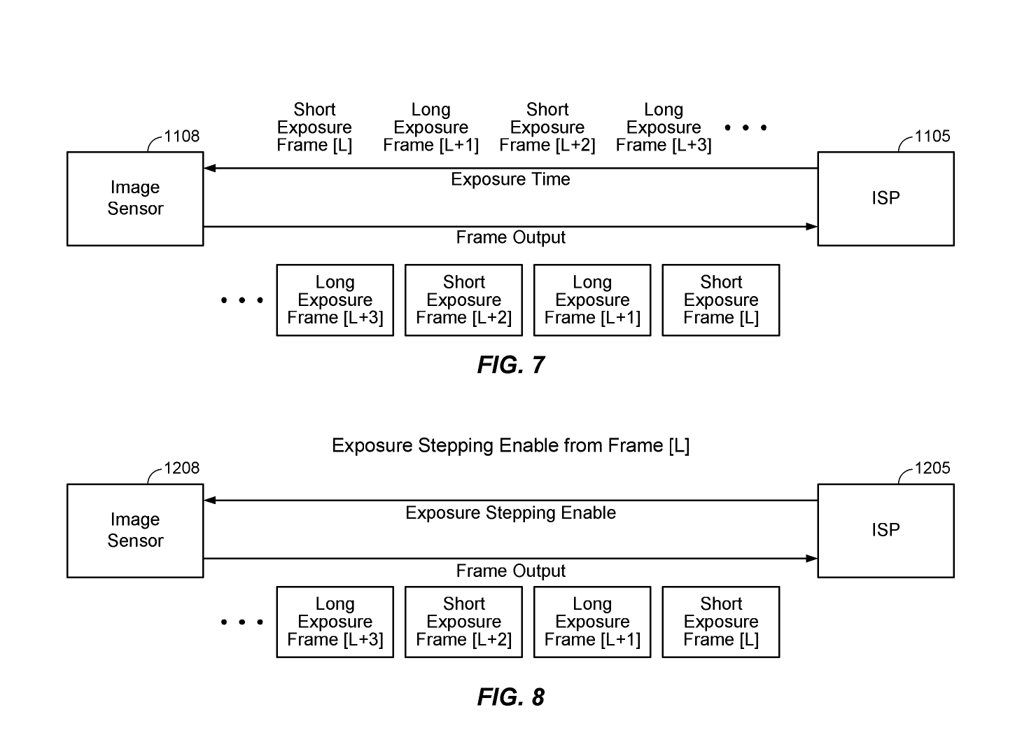

FIG. 7 illustrates a method of an ISP 1105 controlling an image sensor 1108 to enable HDR video capture. For example, the ISP 1105 may transmit to the image sensor 1108, on a frame-by-frame basis, an exposure time for each frame, such as Long Exposure Frame [L+3]. The Image Sensor 1108 may be configured to receive such exposure times from the ISP 1105, and to use those exposure times on a subsequent frame, which may then be transmitted back to the ISP 1105, as illustrated. Such a method may allow an ISP 1105 to control an HDR video capture process.

FIG. 8 illustrates a method of exposure stepping enabling between an ISP 1205 and an Image Sensor 1208. In some aspects, the ISP 1205 may transmit to the Image Sensor 1208 a message to enable exposure stepping. In some aspects, this message may enable exposure stepping beginning at a frame [L]. In some aspects, the Image Sensor 1208 may then be configured to transmit to the ISP 1205 a number of frames of video, configured to enable HDR video. For example, the image sensor 1208 may be configured to transmit a longer exposure frame [L+3], followed by a short exposure frame [L+2], and so on.

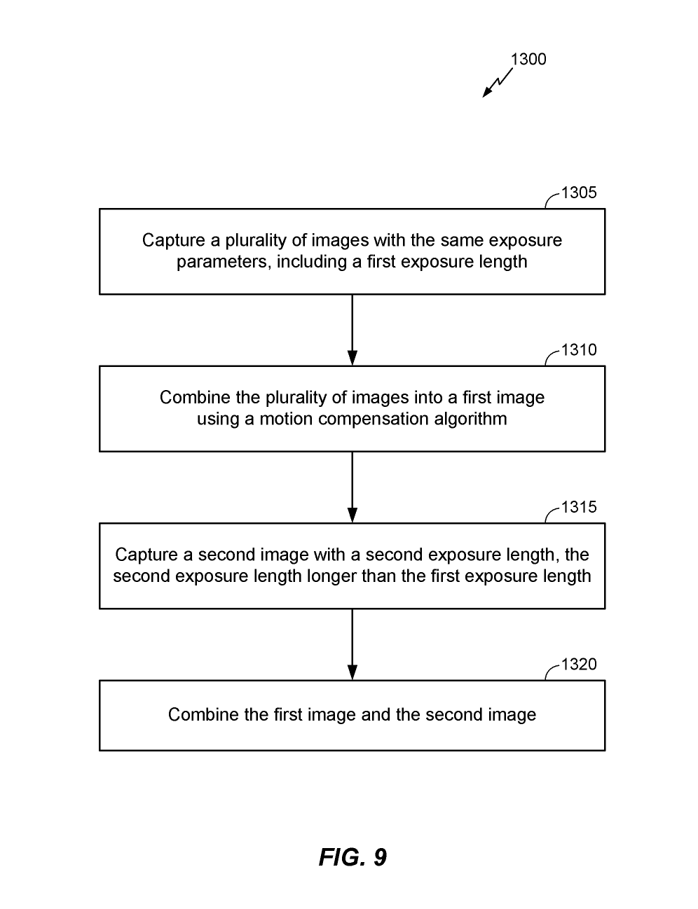

FIG. 9 is an exemplary method of capturing an image. This method may be done by a digital device, such as a digital camera, a cell phone, or another device which includes an image sensor.

At block 1305, the method includes capturing a plurality of images with the same exposure parameters, including a first exposure length. For example, the images may be captured by a single image sensor in a consecutive manner, such as capturing two or more consecutive images with the same exposure parameters. In some aspects, the first exposure length may be a relatively short exposure time. In some aspects, such a short exposure length may be beneficial when capturing relatively bright areas of an image, as a shorter exposure length may prevent pixels from reaching full-well capacity, at which point possible image information regarding color may be lost. In some aspects, the means for capturing a plurality of images may be an image sensor and/or a processor.

At block 1310, the method includes combining the plurality of images into a first image using a motion compensation algorithm. In some aspects, such a motion compensation algorithm may reduce the motion blur which may result from combining a plurality of images. In some aspects, combining a plurality of images may increase the signal-to-noise ratio in the combined image, as compared to any of the individual images. In some aspects, the means for combining images may be a processor.

At block 1315, the method includes capturing a second image with a second exposure length, the second exposure length longer than the first exposure length. In some aspects, the second exposure length may be a relatively long exposure length. In some aspect, the second exposure length may enable an image sensor to capture details in darker regions of an image. In some aspects, a plurality of second images may be captured and combined into a single image. These second images may be combined using a motion compensation technique, in order to reduce motion blur. In some aspects, the means for capturing the second image may be an image sensor and/or a processor.

At block 1320, the method includes combining the first image and the second image. In some aspects, the means for combining the first and the second image may be a processor.

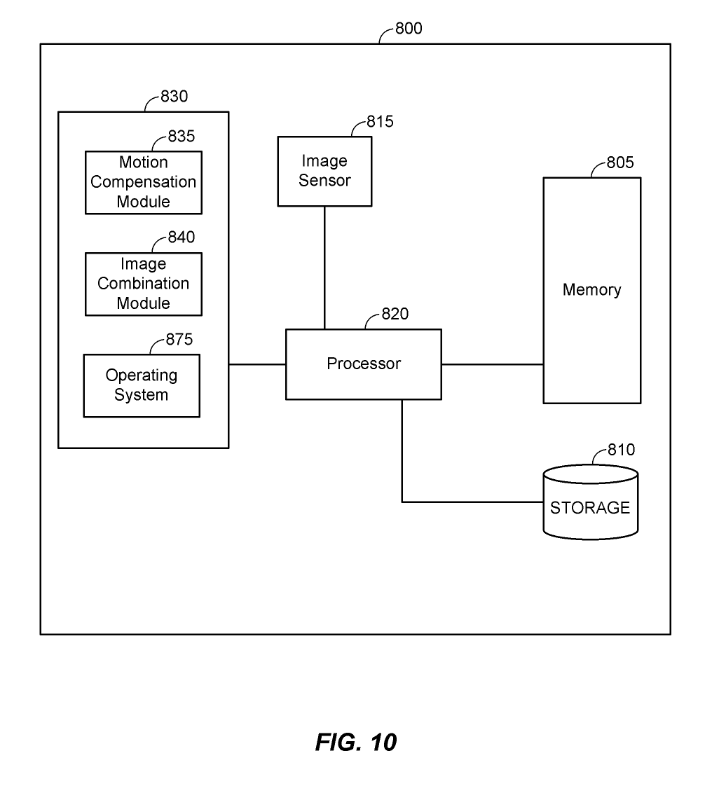

FIG. 10 depicts a high-level block diagram of a device 800 having a set of components including a processor 820 operatively coupled to an image sensor 815. A working memory 805, storage 810, and memory 830 are also in communication with and operative attached to the processor. Device 800 may be a device configured to take digital photograhs and/or videos, such as a digital camera, a cell phone, or another device. The image sensor 815 may be configured to capture a pixel of an image. A number of such pixels may be included on the device 800.

Processor 820 may be a general purpose processing unit or a processor specially designed for the disclosed methods. As shown, the processor 820 is connected to a memory 830 and a working memory 805. In the illustrated embodiment, the memory 830 stores a motion compensation module 835, image combination module 840, and operating system 875. These modules include instructions that configure the processor to perform various tasks. Working memory 805 may be used by processor 820 to store a working set of processor instructions contained in the modules of memory 830. Alternatively, working memory 805 may also be used by processor 820 to store dynamic data created during the operation of device 800.

As mentioned above, the processor 820 is configured by several modules stored in the memories. For example, the motion compensation module 835 may include instructions that configure the processor 820 to compensate for motion which may otherwise cause blurriness in a combined frame when combining a number of frames from the image sensor 815 into a single frame.

The memory 830 may also contain an image combination module 840. The image combination module 840 may contain instructions that configure the processor 820 to receive signals from the image sensor 815, and combine a number of frames from the image sensor 815 into a single frame. In some aspects, the image combination module 840 may be configure to operate in parallel with the motion compensation module 835, in order to combine frames using a motion compensation algorithm in order to reduce motion blur in a combined frame.

Operating system module 875 configures the processor to manage the memory and processing resources of device 800. For example, operating system module 875 may include device drivers to manage hardware resources such as the image sensor 815 or storage 810. Therefore, in some embodiments, instructions contained in modules discussed above may not interact with these hardware resources directly, but instead interact through standard subroutines or APIs located in operating system component 875. Instructions within operating system 875 may then interact directly with these hardware components.

Processor 820 may write data to storage module 810. While storage module 810 is represented graphically as a traditional disk device, those with skill in the art would understand multiple embodiments could include either a disk based storage device or one of several other type storage mediums to include a memory disk, USB drive, flash drive, remotely connected storage medium, virtual disk driver, or the like.

FIG. 10 depicts a device having separate components to include a processor, first and second photodiodes, and memory, one skilled in the art would recognize that these separate components may be combined in a variety of ways to achieve particular design objectives. For example, in an alternative embodiment, the memory components may be combined with processor components to save cost and improve performance.

Additionally, although FIG. 10 illustrates two memory components, to include memory component 830 having several modules, and a separate memory 805 having a working memory, one with skill in the art would recognize several embodiments utilizing different memory architectures. For example, a design may utilize ROM or static RAM memory for the storage of processor instructions implementing the modules contained in memory 830. Alternatively, processor instructions may be read at system startup from a disk storage device that is integrated into device 800 or connected via an external device port. The processor instructions may then be loaded into RAM to facilitate execution by the processor. For example, working memory 805 may be a RAM memory, with instructions loaded into working memory 805 before execution by the processor 820.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may include one or more elements.

A person/one having ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

A person/one having ordinary skill in the art would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein and in connection with FIGS. 1-10 may be implemented within or performed by an integrated circuit (IC), an access terminal, or an access point. The IC may include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. The logical blocks, modules, and circuits may include antennas and/or transceivers to communicate with various components within the network or within the device. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The functionality of the modules may be implemented in some other manner as taught herein. The functionality described herein (e.g., with regard to one or more of the accompanying figures) may correspond in some aspects to similarly designated “means for” functionality in the appended claims.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of forming a high dynamic range image, the method comprising:
capturing a plurality of images with the same exposure parameters, including a first exposure length;
combining the plurality of images into a first image using a motion compensation to prevent image blur;
capturing a second image with a second exposure length, the second exposure length longer than the first exposure length; and
combining the first image and the second image to form the high dynamic range image.

2. The method of claim 1, wherein capturing a second image with a second exposure length comprises capturing a plurality of second images with a second exposure length.

3. The method of claim 1, wherein capturing a plurality of images with the same exposure parameters comprises capturing three or more images with a first exposure length.

4. The method of claim 1, wherein capturing a second image with a second exposure length comprises capturing a plurality of second preliminary images with a second exposure length, further comprising combining the plurality of second preliminary images into a second image using a motion compensation algorithm.

5. The method of claim 1, wherein the plurality of images comprise images captured for consecutive frames of a video.

6. An electronic device, comprising:
a CMOS visible image sensor; and
a processor configured to:
capture a plurality of images with the same exposure parameters, including a first exposure length;
combine the plurality of images into a first image using a motion compensation algorithm;
capture a second image with a second exposure length, the second exposure length longer than the first exposure length; and
combine the first image and the second image.

7. The electronic device of claim 6, wherein capturing a second image with a second exposure length comprises capturing a plurality of second images with a second exposure length.

8. The electronic device of claim 6, wherein capturing a plurality of images with the same exposure parameters comprises capturing three or more images with a first exposure length.

9. The electronic device of claim 6, wherein capturing a second image with a second exposure length comprises capturing a plurality of second preliminary images with a second exposure length, further comprising combining the plurality of second preliminary images into a second image using a motion compensation algorithm.

10. The electronic device of claim 6, wherein the plurality of images comprise images captured for consecutive frames of a video.

11. An electronic device, comprising:
means for capturing a plurality of images with the same exposure parameters, including a first exposure length;
means for combining the plurality of images into a first image using a motion compensation algorithm;
means for capturing a second image with a second exposure length, the second exposure length longer than the first exposure length; and
means for combining the first image and the second image.

12. The electronic device of claim 11, wherein means for capturing a second image with a second exposure length comprises means for capturing a plurality of second images with a second exposure length.

13. The electronic device of claim 11, wherein means for capturing a plurality of images with the same exposure parameters comprises means for capturing three or more images with a first exposure length.

14. The electronic device of claim 11, wherein means for capturing a second image with a second exposure length comprises means for capturing a plurality of second preliminary images with a second exposure length, further comprising means for combining the plurality of second preliminary images into a second image using a motion compensation algorithm.

15. The electronic device of claim 11, wherein the plurality of images comprise images captured for consecutive frames of a video.

16. A non-transitory, computer readable medium comprising instructions that when executed cause a processor in a device to perform a method of capturing an image, the method comprising:
capturing a plurality of images with the same exposure parameters, including a first exposure length;
combining the plurality of images into a first image using a motion compensation algorithm;
capturing a second image with a second exposure length, the second exposure length longer than the first exposure length; and
combining the first image and the second image.

17. The non-transitory, computer readable medium of claim 16, wherein capturing a second image with a second exposure length comprises capturing a plurality of second images with a second exposure length.

18. The non-transitory, computer readable medium of claim 16, wherein capturing a plurality of images with the same exposure parameters comprises capturing three or more images with a first exposure length.

19. The non-transitory, computer readable medium of claim 16, wherein capturing a second image with a second exposure length comprises capturing a plurality of second preliminary images with a second exposure length, further comprising combining the plurality of second preliminary images into a second image using a motion compensation algorithm.

20. The non-transitory, computer readable medium of claim 16, wherein the plurality of images comprise images captured for consecutive frames of a video.
